(19) United States
(12) Patent Application Publication
(10) Pub. No.: US 2010/0144957 A1
(43) Pub. Date: Jun. 10, 2010

(54) CURABLE MATERIAL CONTAINING PHOTOPOLYMERIZABLE POLYMER AND CURED OBJECT

(75) Inventor: Kei Yasui, Funabashi-shi (JP)

Correspondence Address: OLIFF & BERRIDGE, PLC, P.O. BOX 320850, ALEXANDRIA, VA, 22320-4850, US

(73) Assignee: Nissan Chemical Industries , Ltd., Chiyoda-ku, TOKYO (JP)

(21) Appl. No.: 12/450,437

(22) PCT Filed: Mar. 24, 2008
(86) PCT No.: PCT/JP2008/055404

§ 371 Date: Oct. 29, 2009

(30) Foreign Application Priority Data
Mar. 26, 2007 (JP) 2007-080312

(51) Int. Cl. C08F 228/02; C08L 41/00

(52) U.S. Cl. 524/547; 526/288

(57) ABSTRACT

There is provided a curable material capable of manufacturing a cured object by ultraviolet irradiation without using a photopolymerization initiator or additive and a cured object obtained therefrom, and, in particular, provided a film-forming material capable of manufacturing a cured film and the cured film obtained therefrom. The curable material comprises a branched and/or linear photopolymerizable polymer having an N,N-dialkyldithiocarbamate group as a functional group at a molecular end. The film-forming material is composed of the curable material, and the cured object is obtained by photopolymerization of the curable material to effect inter-bonding and the cured film is obtained by photopolymerization of the film-forming material to effect inter-bonding and form a film.

### TECHNICAL FIELD

The present invention relates to curable materials capable of forming a cured object by photoirradiation without any need of adding a polymerization initiator or additives such as an accelerator or crosslinking agent, and in particular, relates to film-forming materials capable of forming a cured film and the cured film obtained therefrom.

The materials can be suitably used as, for example, paint, ink, adhesives, resin fillers, various forming materials, photonic crystals, resist materials, optical materials, electronic materials, information recording materials, printing materials, battery materials, medical materials, or magnetic materials.

### BACKGROUND ART

Conventionally, hyperbranched polymers (HBP) together with dendrimers are classified as dendritic polymers.

While conventional polymer compounds generally have a string (linear) shape, specific polymer structures and the expression of various functions are expected by actively introducing branches into dendritic polymers. For example, due to the above-mentioned multi-branched structure, the polymer has a nanometer-order molecular size and a polymer structure with surface conditions capable of retaining numerous functional groups, as well as exhibiting various characteristics such as a viscosity lower than that of a linear polymer, a particulate behavior that exhibits a low level of intermolecular entanglement, and a solvent solubility that can be controlled due to its amorphous properties. Such polymers are expected to be applied to a wide range of technical fields by using these characteristics.

Especially, an example of the most distinctive feature of dendritic polymers is the large number of end groups. In a dendritic polymer, generally, the number of branches increases in correspondence with the increase in molecular weight, so that as the molecular weight of a dendritic polymer increases, the absolute number of end groups also increases correspondingly.

Such dendritic polymers with a large number of end groups have a feature that general linear polymers do not have in which the glass-transition temperature, solubility, thin-film forming property and the like vary widely because the intermolecular interaction largely depends on the types of end groups.

Furthermore, when reactive functional groups are attached to the end groups, the polymer gains reactive functional groups with a very high density due to the molecular form, so that expected applications include a highly sensitive scavenger for functional substances, highly sensitive multifunctional crosslinking agent, and dispersant or coating agent for metals or metal oxides. Accordingly, in a dendritic polymer, the manner in which the type of end group is specified is an important factor in relation to which polymer characteristics are exhibited.

Within photocurable resin compositions, ultraviolet-cured type photocurable resin compositions cured by the irradiation of ultraviolet rays are generally used in a wide variety of fields. These photocurable resin compositions generally include monomers, oligomers and a photopolymerization initiator, as well as an accelerator and crosslinking agent as necessary. They also include various additives (stabilizer, filler, dye and the like) for improving characteristics such as stability and strength.

No polymerization reaction readily occurs with a composition only containing monomers and oligomers, so that the reaction needs to be started with a photopolymerization initiator. The photopolymerization initiator absorbs light to be activated (excited), and causes reactions such as a cleavage reaction, hydrogen abstraction and electron transfer to generate substances such as radical molecules and hydrogen ions which start the reaction. Then, the generated radical molecules, hydrogen ions and the like attack oligomer and monomer molecules to cause three dimensional polymerization or cross-linking reaction.

When these reactions produce a molecule with a certain size or larger, the areas where reactions are created by the photoirradiation change from the liquid state to the solid state.

Until now, it has been disclosed that the application of electron beam irradiation to a dendrimer having vinyl groups at the ends as a curable resin composition, such as paint, will form a cured film (for example, Patent Document 1).

Furthermore, it has been disclosed that radical species are generated by application of photoirradiation and the like to a dithiocarbamate compound, with the subsequent promotion of living radical polymerization to obtain a hyperbranched polymer having dithiocarbamate groups at the ends (Patent Document 2).

### [Patent Document 1]

Japanese Patent Application Publication No. JP-A-11-335429

### [Patent Document 2]

International Publication WO 2006/093050 pamphlet

### DISCLOSURE OF THE INVENTION

### Problem to be Solved by the Invention

As described above, photopolymerization initiators and additives generally used in conventional photo-curing processes often become residual components that cause degradation of the cured film, such as an odor, coloration and deterioration.

However, Patent Document 1 does not describe that a cured film can be obtained by ultraviolet irradiation without using a photopolymerization initiator. Furthermore, Patent Document 2 does not disclose the hyperbranched polymer exhibits any photocurable characteristics.

In view of the above, it is an object of the present invention to provide a curable material capable of manufacturing a cured object by ultraviolet irradiation without using a photopolymerization initiator or additive and the cured object obtained therefrom, and, in particular, to provide a film-forming material capable of manufacturing a cured film and the cured film obtained therefrom.

### Means for Solving the Problem

The present inventors have carried out intensive studies in order to achieve the above-mentioned object, and as a result, have found that a cured film is easily formed by the application of photoirradiation to a thin film coated with a branched and/or linear photopolymerizable polymer having an N,N-dialkyldithiocarbamate group as a functional group at a molecular end.

That is, as a first aspect, the present invention relates to a curable material including a branched and/or linear photopolymerizable polymer having an N,N-dialkyldithiocarbamate group as a functional group at a molecular end.

As a second aspect, the present invention relates to the curable material according to the first aspect in which the photopolymerizable polymer is a branched photopolymerizable polymer represented by Formula (1):

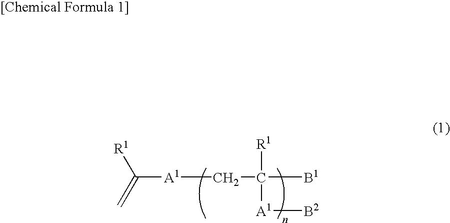

(where R¹ represents a hydrogen atom or methyl group, A¹ represents Formula (2) or Formula (3):

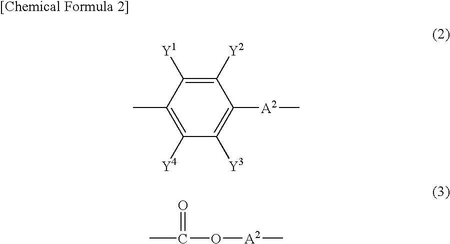

(where A² represents a straight chain, branched chain or cyclic alkylene group with 1 to 30 carbon atoms, which may contain an ether linkage or ester linkage, and Y¹, Y², Y³ or Y⁴ independently represents a hydrogen atom, alkyl group with 1 to 20 carbon atoms, alkoxy group with 1 to 20 carbon atoms, nitro group, hydroxy group, amino group, carboxyl group or cyano group), B¹ or B² independently represents a hydrogen atom, thiol group or dithiocarbamate group represented by Formula (4):

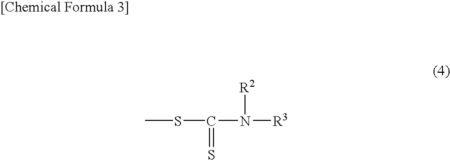

(where each of R² and R³ independently represents an alkyl group with 1 to 5 carbon atoms, hydroxyalkyl group with 1 to 5 carbon atoms or arylalkyl group with 7 to 12 carbon atoms, or R² and R³ may be bonded to each other to form a ring together with a nitrogen atom), and n is the number of a repeating unit structure and represents an integer of 2 to 100,000).

As a third aspect, the present invention relates to the curable material according to the first aspect in which the photopolymerizable polymer is a linear photopolymerizable polymer represented by Formula (5):

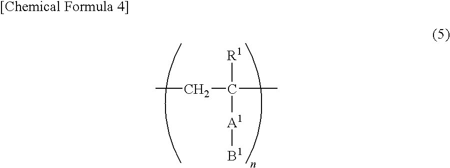

(where R¹, A¹, B¹ and n are the same as the respective definitions in Formula (1)).

As a fourth aspect, the present invention relates to the curable material according to the second aspect in which the photopolymerizable polymer represented by Formula (1) has a weight average molecular weight, measured by gel permeation chromatography converted to polystyrene, of 500 to 200,000.

As a fifth aspect, the present invention relates to the curable material according to the third aspect in which the photopolymerizable polymer represented by Formula (5) has a weight average molecular weight, measured by gel permeation chromatography converted to polystyrene, of 500 to 200,000.

As a sixth aspect, the present invention relates to a film-forming material including the curable material as described in the first aspect to the fifth aspect.

As a seventh aspect, the present invention relates to a cured object obtained by photopolymerization of the curable material as described in the first aspect to the fifth aspect to effect inter-bonding.

As an eighth aspect, the present invention relates to a cured film obtained by photopolymerization of the film-forming material as described in the sixth aspect to effect inter-bonding and form a film.

### Effects of the Invention

The photopolymerizable polymer (hyperbranched polymer) contained in the curable material of the present invention has, even after polymerization (generally, in a particulate shape), a structure with dithiocarbamate groups at all or a part (generally, a large part) of the molecular ends, so that a substance containing the photopolymerizable polymer is photoirradiated with a predetermined wavelength to further progress the photopolymerization reaction, and the polymers are bonded to one another to finally form a cured object with a film shape in general.

Accordingly, the curable material of the present invention has a great advantage in which a cured object (in particular, a cured film) can be easily and efficiently obtained simply by a photopolymerization reaction without any need of adding a polymerization initiator or additives such as an accelerator or crosslinking agent.

Furthermore, since the photopolymerizable polymer of the present invention has dithiocarbamate groups at the molecular ends and the dithiocarbamate groups can be easily modified, a solvent which can dissolve or disperse the curable material containing the polymer has a high degree of freedom, and furthermore, viscosity control and modifications in dispersion characteristic are easy, so that curable materials containing various solvents (for example, a varnish form of a photopolymerizable polymer) can be composed for required applications and can be used for applications for forming various cured objects (for example, a film).

Furthermore, since the cured object of the present invention formed from the above-mentioned curable material contains no additive such as the polymerization initiator, the cured object provides an advantageous effect of causing no performance degradation of the cured object, such as coloration or deterioration that can be caused by the presence of additives.

In addition, the cured film of the present invention formed from the film-forming material of the present invention contains no additive such as the polymerization initiator. Therefore, when the cured film is used as an insulating film, for example, the cured film provides an advantageous effect of causing no performance degradation of the cured film, such as deterioration of the insulation performance that can be caused by the presence of the additives.

Moreover, in the cured film of the present invention, since the photopolymerizable polymers (hyperbranched polymers) are bonded to one another by the photopolymerization reaction to form a huge matrix polymer, the cured film has an excellent characteristic of not readily exfoliating from a substrate.

In addition, during the photopolymerization reaction, a pattern exposure with a shadow mask allows pattern formation.

Furthermore, when branched and/or linear photopolymerizable polymers with various refractive indexes are cured and recoated, an antireflection film or diffraction grating can be easily provided.

Additionally, a photopolymerizable hyperbranched polymer with a high refractive index (for example, in the case where A¹ is represented by Formula (2) in the photopolymerizable polymer represented by Formula (1)) is pattern exposed to form a core, and then an optical waveguide having a clad formed from a branched and/or linear polymer with a low refractive index, or a thermal- or photo-polymer of a polymerizable compound with a low refractive index can be manufactured. Similarly, a photopolymerizable hyperbranched polymer with a low refractive index (for example, in the case where A′ is represented by Formula (3) in the photopolymerizable polymer represented by Formula (1)) is pattern exposed to form a clad, and then an optical waveguide having a core formed from a branched and/or linear polymer with a high refractive index, or a thermal- or photo-polymer of a polymerizable compound with a high refractive index can be manufactured.

Therefore, the cured film formed from the film-forming material containing the photopolymerizable polymer of the present invention can be suitably used, for example, as a gate insulating layer. When the gate insulating layer formed from the cured film is contained in an organic semiconductor device, not only a top-contact type FET but also a bottom-contact type FET can be fabricated, and further the organic semiconductor device can work with both n- and p-type organic semiconductor layers therein, so that its industrial applications can be extended in wide fields.

### BEST MODES FOR CARRYING OUT THE INVENTION

Hereinafter, the present invention will be described in detail.

Examples of photopolymerizable polymers used for the curable material or the film-forming material of the present invention include a branched photopolymerizable polymer represented by Formula (1) or linear photopolymerizable polymer represented by Formula (5):

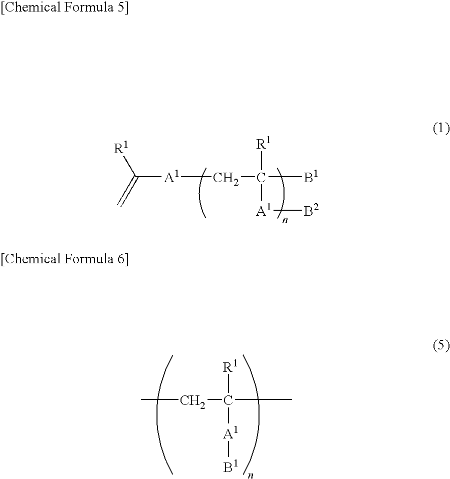

In Formula (1) or Formula (5), R¹ represents a hydrogen atom or methyl group. n is the number of repeating unit structures and represents an integer of 2 to 100,000.

In Formula (1) or Formula (5), A¹ represents a structure represented by Formula (2) or Formula (3):

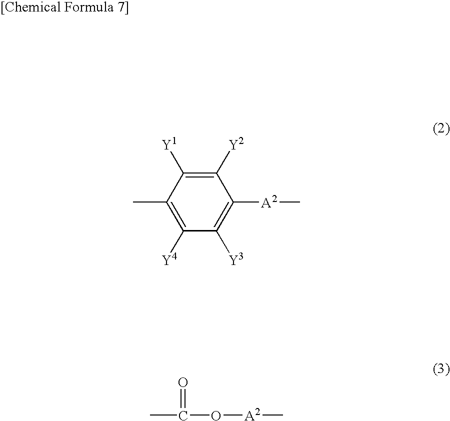

In Formula (2) and Formula (3), A² represents a straight chain, branched or cyclic alkylene group with 1 to 30 carbon atoms, which may include an ether linkage or ester linkage.

Specific examples of the straight chain alkylene group include a methylene group, ethylene group, normal propylene group, normal butylene group, and normal hexylene group. Furthermore, specific examples of the branched chain alkylene group include an isopropylene group, isobutylene group, and 2-methylpropylene group.

Furthermore, examples of the cyclic alkylene group include an alicyclic-aliphatic group having a cyclic structure of a monocycle, polycycle or cross-linked cycle with 3 to 30 carbon atoms. Specific examples of the cyclic alkylene group include groups having a monocyclo, bicyclo, tricyclo, tetracyclo, pentacyclo structure or the like with 4 or more carbon atoms. Hereinafter, as for the alicyclic-aliphatic group, example structures (a) to (s) of an alicyclic part will be shown:

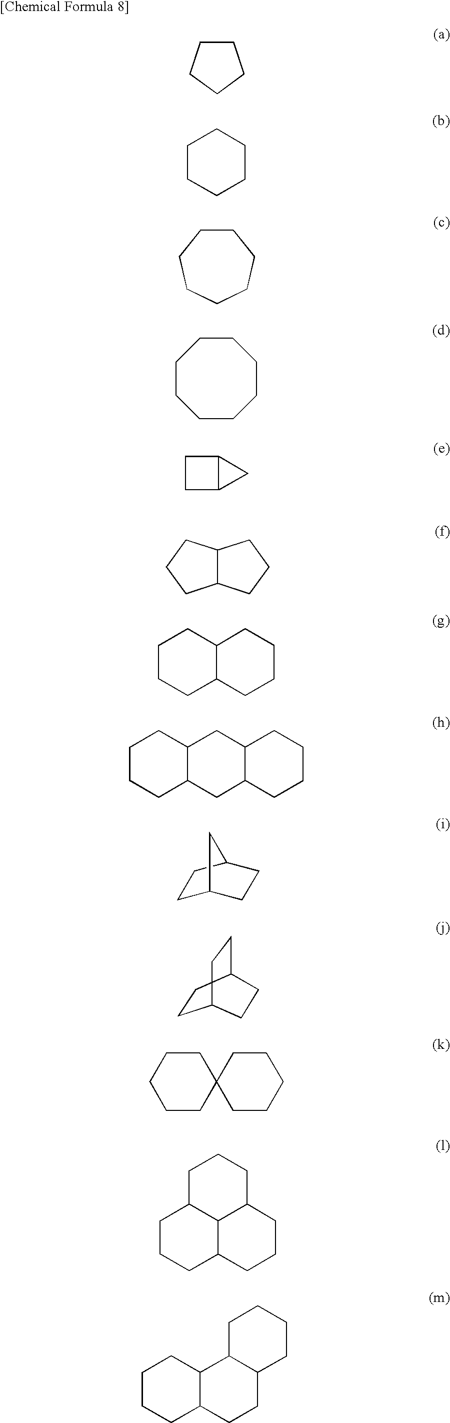

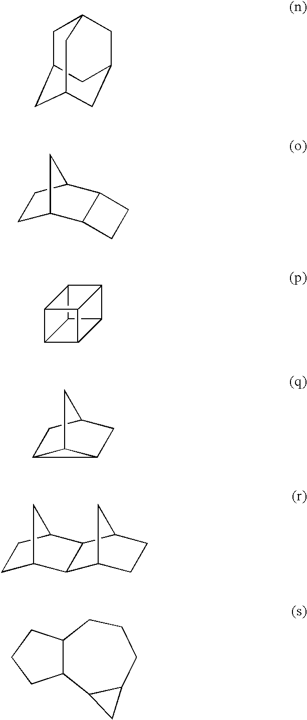

Furthermore, in Formula (2) and Formula (3), each of Y¹, Y², Y³ and Y⁴ independently represents a hydrogen atom, alkyl group with 1 to 20 carbon atoms, alkoxy group with 1 to 20 carbon atoms, halogen group, nitro group, hydroxy group, amino group, carboxyl group or cyano group.

Examples of the alkyl group with 1 to 20 carbon atoms include a methyl group, ethyl group, isopropyl group, cyclohexyl group, and normal pentyl group.

Examples of the alkoxy group with 1 to 20 carbon atoms include a methoxy group, ethoxy group, isopropoxy group, cyclohexyloxy group, and normal pentyloxy group.

Examples of the halogen group include a fluoro group, chloro group, bromo group and iodine group.

Y¹, Y², Y³ and Y⁴ are specifically preferably a hydrogen atom or alkyl group with 1 to 20 carbon atoms.

Furthermore, in Formula (1) or Formula (5), each of B¹ and B² independently represents a hydrogen atom, thiol group or dithiocarbamate group represented by Formula (4):

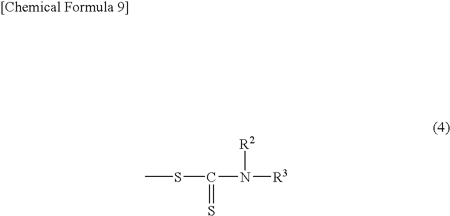

In Formula (4), each of R² and R³ independently represents an alkyl group with 1 to 5 carbon atoms, hydroxyalkyl group with 1 to 5 carbon atoms or arylalkyl group with 7 to 12 carbon atoms. Alternatively, R² and R³ may be bonded to each other to form a ring together with a nitrogen atom.

Examples of the alkyl group with 1 to 5 carbon atoms include a methyl group, ethyl group, isopropyl group, t-butyl group, cyclopentyl group, and normal pentyl group.

Examples of the hydroxyalkyl group with 1 to 5 carbon atoms include a hydroxymethyl group, hydroxylethyl group, and hydroxypropyl group.

Examples of the arylalkyl group with 7 to 12 carbon atoms include a benzyl group and phenethyl group.

Examples of the ring formed by bonding R² and R³ to each other together with the nitrogen atom being bonded to them include 4- to 8-membered rings. In addition, examples of the ring include a ring containing 4 to 6 methylene groups. Furthermore, examples of the ring also include a ring containing an oxygen atom or sulfur atom and 4 to 6 methylene groups.

Specific examples of the ring formed by bonding R² and R³ to each other together with the nitrogen atom being bonded to them include a piperidine ring, pyrrolidine ring, morpholine ring, thiomorpholine ring, and homopiperidine ring.

The present invention also relates to a branched photopolymerizable polymer represented by Formula (1) or linear photopolymerizable polymer represented by Formula (5).

The photopolymerizable polymer has a weight average molecular weight Mw measured by gel permeation chromatography converted to polystyrene, of 500 to 5,000,000, preferably 500 to 1,000,000, more preferably 500 to 200,000, and specifically preferably 3,000 to 100,000.

Furthermore, the degree of dispersion of the photopolymerizable polymer used for the curable material or the film-forming material of the present invention (Mw (weight average molecular weight)/Mn (number average molecular weight)) is 1.0 to 7.0, preferably 1.1 to 6.0, and more preferably 1.2 to 5.0.

### (Method for Producing Photopolymerizable Polymer)

In the above-mentioned photopolymerizable polymer, the branched photopolymerizable polymer having dithiocarbamate groups at the molecular ends can be synthesized by, for example, the synthetic method by photopolymerization of a styrene compound having dithiocarbamate groups (Koji Ishizu, Akihide Mori, Macromol. Rapid Commun. 21, 665-668 (2000), Koji Ishizu, Akihide Mori, Polymer International 50, 906-910 (2001), Koji Ishizu, Yoshihiro Ohta, Susumu Kawauchi, Macromolecules Vol. 35, No. 9, 3781-3784 (2002)) and the synthetic method by photopolymerization of an acrylic compound having dithiocarbamate groups (Koji Ishizu, Takeshi Shibuya, Akihide Mori, Polymer International 51, 424-428 (2002), Koji Ishizu, Takeshi Shibuya, Susumu Kawauchi, Macromolecules Vol. 36, No. 10, 3505-3510 (2002), Koji Ishizu, Takeshi Shibuya, Jaebum Park, Satoshi Uchida, Polymer International 53, 259-265 (2004)).

Specifically, in the presence of a dithiocarbamate compound represented by Formula (6):

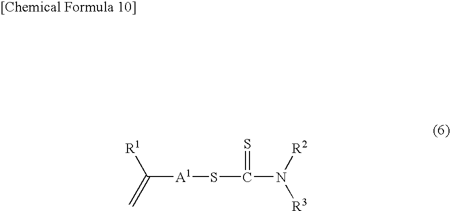

(where R¹ and A¹ are the same as the respective definitions in Formula (1), and R² and R³ are the same as the respective definitions in Formula (4)), that is, in the presence of both a dithiocarbamate compound in which A¹ represents Formula (2) and a dithiocarbamate compound in which A¹ represents Formula (3), a method including a process of living radical polymerization can be used to obtain a photopolymerizable polymer having a branched repeating unit structure represented by Formula (7):

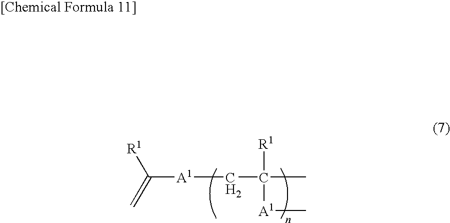

(where R¹ and A¹ are the same as the respective definitions in Formula (1)), and furthermore, the same polymerization method can be used to obtain a photopolymerizable polymer having dithiocarbamate groups at the molecular ends (that is, the photopolymerizable polymer represented by Formula (1)).

The above-mentioned living radical polymerization can be carried out in known polymerization manners such as bulk polymerization, solution polymerization, suspension polymerization and emulsification polymerization, and solution polymerization in an organic solvent solution is preferred.

Solution polymerization is carried out by a polymerization reaction using the dithiocarbamate compound in which A¹ represents Formula (2) and the dithiocarbamate compound in which A¹ represents Formula (3) as the dithiocarbamate compounds represented by Formula (6) at any concentrations in an organic solvent solution capable of dissolving the compounds. For example, the ratio of the dithiocarbamate compound in which A¹ represents Formula (3) with respect to the dithiocarbamate compound in which A¹ represents Formula (2) is 0.01 to 99 molar equivalent, preferably 0.05 to 19 molar equivalent, and more preferably 0.1 to 9 molar equivalent.

Furthermore, in the case of solution polymerization, the total amount of the dithiocarbamate compound in which A¹ represents Formula (2) and the dithiocarbamate compound in which A¹ represents Formula (3) used as the dithiocarbamate compounds represented by Formula (6) in a solution is 1 to 80% by mass, preferably 2 to 70% by mass, and more preferably 5 to 60% by mass, with respect to the gross mass (the total mass of the dithiocarbamate compound in which A¹ represents Formula (2), the dithiocarbamate compound in which A¹ represents Formula (3) and the organic solvent).

The organic solvent is not specifically limited as far as the organic solvent can dissolve the dithiocarbamate compound in which A¹ represents Formula (2) and the dithiocarbamate compound in which A¹ represents Formula (3) used as dithiocarbamate compounds represented by Formula (6). Examples of the organic solvent include aromatic hydrocarbons such as benzene, toluene, xylene and ethylbenzene, ether compounds such as tetrahydrofuran and diethyl ether, ketone compounds such as acetone, methyl ethyl ketone, methyl isobutyl ketone and cyclohexanone, aliphatic hydrocarbons such as normal heptane, normal hexane and cyclohexane. These organic solvents may be used singly or as a mixture of two or more of them.

The living radical polymerization in the presence of both a dithiocarbamate compound represented by Formula (6) in which A¹ represents Formula (2) and a dithiocarbamate compound represented by Formula (6) in which A¹ represents Formula (3) can be carried out in an organic solvent solution by heating or photoirradiation of ultraviolet rays and the like, but is preferably carried out by the photoirradiation of ultraviolet rays and the like. The photoirradiation can be carried out with an ultraviolet ray irradiation lamp such as a low pressure mercury lamp, high pressure mercury lamp, extra-high pressure mercury lamp and xenon lamp, and by internal or external irradiation of a reaction system.

For the living radical polymerization, before the start of the polymerization, oxygen in the reaction system needs to be thoroughly removed, and is preferably replaced with an inert gas such as nitrogen or argon in the system.

The polymerization time is 0.1 to 100 hours, preferably 1 to 50 hours, and more preferably 3 to 30 hours. Generally, with the progress of the polymerization time, the conversion rate of monomers (a dithiocarbamate compound represented by Formula (6) in which A¹ represents Formula (2) and a dithiocarbamate compound represented by Formula (6) in which A¹ represents Formula (3)) increases. The polymerization temperature is not specifically limited, but is 0 to 200° C., preferably 10 to 150° C., and more preferably 20 to 100° C.

During the living radical polymerization in the presence of both a dithiocarbamate compound represented by Formula (6) in which A¹ represents Formula (2) and a dithiocarbamate compound represented by Formula (6) in which A¹ represents Formula (3), a chain transfer agent such as mercaptans and sulfides or a sulfide compound such as tetraethylthiuram disulfide may be used in order to control the molecular weight and molecular weight distribution. Furthermore, as desired, an antioxidant such as hindered phenols, ultraviolet absorber such as benzotriazoles, and polymerization inhibitor such as 4-tert-butylcatechol, hydroquinone, nitrophenol, nitrocresol, picric acid, phenothiazine and dithiobenzoyl disulfide may be used.

Furthermore, during the living radical polymerization, known vinyl monomers without any dithiocarbamate groups or compounds with unsaturated double bonds may be added in order to control the degree of branching or of polymerization. These monomers and compounds can be used with a ratio of less than 50% by mol with respect to the gross amount of the dithiocarbamate compound in which A¹ represents Formula (2) and the dithiocarbamate compound in which A¹ represents Formula (3) used as a dithiocarbamate compounds represented by Formula (6). Specific examples of these monomers and compounds include styrenes, vinylbiphenyls, vinylnaphthalenes, vinylanthracenes, acrylic acid esters, methacrylic acid esters, acrylamides, methacrylamides, vinylpyrrolidones, acrylonitriles, maleic acids, maleimides, divinyl compounds, and trivinyl compounds.

A dithiocarbamate compound represented by Formula (6) can be easily obtained from a nucleophilic substitution reaction of a compound represented by Formula (8) and a compound represented by Formula (9):

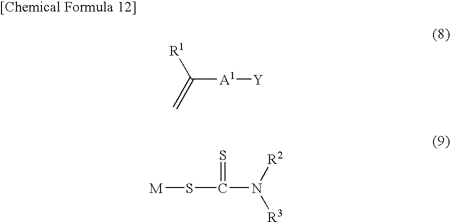

In Formula (8), Y represents an elimination group. Examples of the elimination group include a fluoro group, chloro group, bromo group, iodine group, mesyl group, and tosyl group. In Formula (9), M represents lithium, sodium or potassium.

The nucleophilic substitution reaction is generally preferably carried out in an organic solvent which can dissolve both of the above-mentioned two types of compounds. After the reaction, a dithiocarbamate compound represented by Formula (6) can be obtained with a high purity by liquid separation treatment with water and a nonaqueous organic solvent or recrystallization treatment. Furthermore, a dithiocarbamate compound represented by Formula (6) can be produced with reference to the method described in Macromol. Rapid Commun. 21, 665-668 (2000) or Polymer International 51, 424-428 (2002).

Specific examples of the dithiocarbamate compound represented by Formula (6) include N,N-diethyldithiocarbamylmethylstyrene and the like as the dithiocarbamate compound in which A¹ represents Formula (2), and include N,N-diethyldithiocarbamylethylmethacrylate and the like as the dithiocarbamate compound in which A¹ represents Formula (3).

### (Methods for Reducing and Transforming Dithiocarbamate Group Existing at Molecular End of Photopolymerizable Polymer)

Furthermore, the photopolymerizable polymer used for the curable material or the film-forming material of the present invention may have a hydrogen atom formed by the reduction of dithiocarbamate groups existing at the ends.

Reducing the photopolymerizable polymers obtained as described above and having the dithiocarbamate groups at the molecular ends, that is, transforming the dithiocarbamate group at the molecular end into a hydrogen atom creates a photopolymerizable polymer represented by Formula (10):

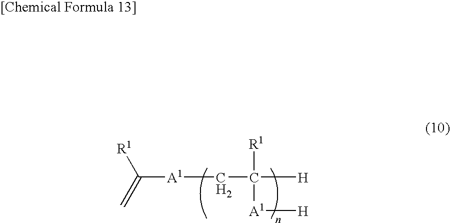

(where R¹ and A¹ are the same as the respective definitions in Formula (1)) having the structure in which a branched repeating unit represented by Formula (4) in which A¹ represents Formula (2) and the branched repeating unit represented by Formula (4) in which A¹ represents Formula (3) are linked in the branched repeating unit structure represented by Formula (7) of the present invention, and having hydrogen atoms at the molecular ends.

The reduction method is not specifically limited as far as the method can transform a dithiocarbamate group into a hydrogen atom, and for example, the reduction reaction can be carried out with a known reducing agent such as hydrogen, hydrogen iodide, hydrogen sulfide, lithium aluminum hydride, sodium borohydride, tributyltin hydride, tris(trimethylsilyl)silane and thioglycolic acid.

The amount used of the reducing agent is 1 to 20 fold molar equivalents, preferably 1.5 to 10 fold molar equivalents, and more preferably 1.8 to 5 fold molar equivalents, with respect to the number of dithiocarbamate groups in the photopolymerizable polymer.

The conditions of the reduction reaction are accordingly selected from a reaction time of 0.01 to 100 hours and a reaction temperature of 0 to 200° C. Preferably, the reaction time is 0.1 to 10 hours and the reaction temperature is 20 to 100° C.

The reduction reaction is preferably carried out in water or an organic solvent. A preferable solvent to be used is a solvent which can dissolve the above-mentioned photopolymerizable polymer having dithiocarbamate groups and a reducing agent. Furthermore, the same solvent as used to produce the photopolymerizable polymer having dithiocarbamate groups is preferred due to an easy reaction operation.

A preferable reduction method is that, in an organic solvent solution, a compound such as tributyltin hydride which is used for the reduction reaction under a radical reaction condition is used as a reducing agent and the reduction is carried out by photoirradiation.

Examples of the organic solvent that can be used include aromatic hydrocarbons such as benzene, toluene, xylene and ethylbenzene, ether compounds such as tetrahydrofuran and diethyl ether, ketone compounds such as acetone, methyl ethyl ketone, methyl isobutyl ketone and cyclohexanone, aliphatic hydrocarbons such as normal heptane, normal hexane and cyclohexane. These solvents may be used singly or as a mixture of two or more of them.

Photoirradiation can be carried out with an ultraviolet ray irradiation lamp such as a low pressure mercury lamp, high pressure mercury lamp, extra-high pressure mercury lamp and xenon lamp, and by internal or external irradiation of a reaction system.

In the reduction reaction, a reducing agent such as tributyltin hydride can be used in 1 to 10 fold molar equivalents, preferably 1.5 to 5 fold molar equivalents, and more preferably 1.8 to 4 fold molar equivalents, with respect to the number of dithiocarbamate groups in the photopolymerizable polymer.

Furthermore, preferably, the mass of the organic solvent to be used is 0.2 to 1000 times the mass, preferably 1 to 500 times the mass, more preferably 5 to 100 times the mass, and most preferably 10 to 50 times the mass, of the hyperbranched polymer having dithiocarbamate groups at the molecular ends.

Furthermore, as for the reduction reaction, before the start of the reaction, oxygen in the reaction system needs to be thoroughly removed, and may be replaced with an inert gas such as nitrogen or argon in the system. The reaction conditions are accordingly selected from a reaction time of 0.01 to 100 hours and a reaction temperature of 0 to 200° C. Preferably, the reaction time is 0.1 to 2 hours and the reaction temperature is 20 to 60° C.

The photopolymerizable polymer which is obtained from the above-mentioned reduction reaction and which is contained in the curable material or the film-forming material of the present invention can be separated from the solvent in the reaction solution by solvent removal through distillation or solid-liquid separation. Furthermore, the reaction solution is added to a poor solvent to precipitate the photopolymerizable polymer used for the curable material or the film-forming material of the present invention, and then the polymer can be recovered as powder.

The photopolymerizable polymer containing hydrogen atoms at the molecular ends used for the curable material or the film-forming material of the present invention may contain residual dithiocarbamate groups at a part of the molecular ends.

Furthermore, the photopolymerizable polymer used for the curable material or the film-forming material of the present invention may have thiol groups formed by the transformation of the carbamate groups existing at the ends.

Treating the photopolymerizable polymer having dithiocarbamate groups at the molecular ends with a thiolating agent, that is, transforming the dithiocarbamate groups into the thiol groups creates the photopolymerizable polymer having thiol groups at molecular ends represented by Formula (11):

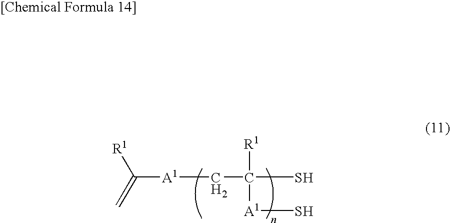

The reaction method is not specifically limited as far as the method can transform the dithiocarbamate groups into the thiol groups, and for example, the thiolation reaction can be carried out by using a thiolating agent such as hydrazine, benzylhydrazine, ammonia, metallic sodium, sodium hydroxide, potassium hydroxide, lithium aluminum hydride, sodium borohydride, hydrogen bromide, hydrochloric acid, trifluoroacetic acid and mercury diacetylate.

The amount used of the thiolating agent may be 1 to 200 fold molar equivalents, or 2 to 100 fold molar equivalents, or 2.5 to 80 fold molar equivalents, or 3 to 50 fold molar equivalents, with respect to the number of dithiocarbamate groups in the photopolymerizable polymer.

The conditions for the thiolation reaction are accordingly selected from a reaction time of 0.01 to 100 hours and a reaction temperature of 0 to 200° C. Preferably, the reaction time is 1 to 80 hours and the reaction temperature is 20 to 150° C.

The thiolation reaction is preferably carried out in water or an organic solvent. The solvent to be used is preferably a solvent which can dissolve the photopolymerizable polymer having dithiocarbamate groups and the thiolating agent. Furthermore, the same solvent as used to produce the photopolymerizable polymer having dithiocarbamate groups is preferred due to an easy reaction operation.

A preferable thiolation reaction method is that, in an organic solvent solution, a compound such as hydrazine is used and the reactant is heated to reflux.

Examples of the organic solvent that can be used include aromatic hydrocarbons such as benzene, toluene, xylene and ethylbenzene, ether compounds such as tetrahydrofuran, 1,4-dioxane and diethyl ether, ketone compounds such as acetone, methyl ethyl ketone, methyl isobutyl ketone and cyclohexanone, aliphatic hydrocarbons such as normal heptane, normal hexane and cyclohexane. These solvents may be used singly or as a mixture of two or more of them.

Furthermore, the mass of the organic solvent to be used is preferably 0.2 to 1000 times the mass, or 1 to 500 times the mass, or 5 to 100 times the mass, or 10 to 50 times the mass, of the photopolymerizable polymer having dithiocarbamate groups at the molecular ends.

Furthermore, as for the reaction, before the start of the reaction, oxygen in the reaction system needs to be thoroughly removed, and may be replaced with an inert gas such as nitrogen or argon in the system.

The photopolymerizable polymer of the present invention obtained from the above-mentioned thiolation reaction can be separated from the solvent in the reaction solution by solvent removal through distillation or solid-liquid separation. Furthermore, the reaction solution is added to a poor solvent to precipitate the photopolymerizable polymer of the present invention, and then the polymer can be recovered as powder.

The photopolymerizable polymer having thiol groups at the molecular ends used for the curable material or the film-forming material of the present invention may contain residual dithiocarbamate groups at a part of the molecular ends.

The specific examples of the photopolymerizable polymer used for the curable material or the film-forming material of the present invention will be described below along with a reaction scheme. Here, as an example, a monomer for the basic structure is designated as N,N-diethyldithiocarbamylmethylstyrene (S-DC).

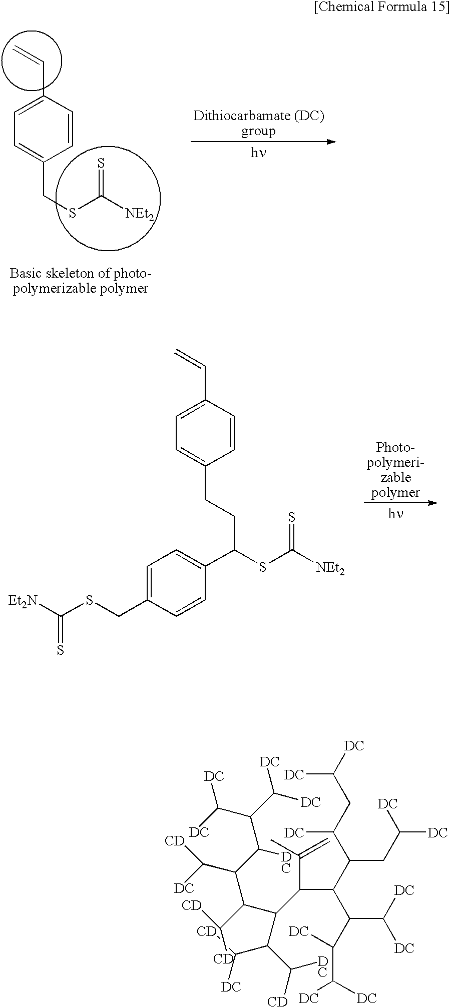

As shown in the above-mentioned reaction scheme, the photopolymerizable polymer obtained from the photopolymerization of S-DC has dithiocarbamate groups at the molecular ends.

Accordingly, photoirradiation of ultraviolet rays and the like to the photopolymerizable polymer causes bond cleavage between the dithiocarbamate group and the adjacent carbon atom to generate radical species.

The radical species reacts with other adjacent molecules of the photopolymerizable polymer to form a polymer, and by continuing photoirradiation, the successive generation and reaction of the radical species are repeated to finally form a large matrix polymer (that is, a cured object or a film).

### (Coated Film and Cured Film)

Specific methods for forming a cured film from a film-forming material containing the photopolymerizable polymer of the present invention are as follows. First, the photopolymerizable polymer is dissolved or dispersed in a solvent to make a varnish form (film-forming material). The varnish is coated on a substrate by spin coating, blade coating, dip coating, roll coating, bar coating, die coating, ink-jetting, printing (relief, intaglio, planographic, screen printing or the like) or the like. Then, the vanish is predried with a hot plate, oven or the like to form a coating film.

Among these coating methods, spin coating is preferred. When spin coating is used, because coating can be performed in a short time, there are advantages in which even a solution with a high volatility can be used and furthermore coating with a high uniformity can be performed.

Examples of the organic solvent that can be used in the above-mentioned varnish form include aromatic hydrocarbons such as benzene, toluene, xylene and ethylbenzene, ether compounds such as tetrahydrofuran and diethyl ether, ketone compounds such as acetone, methyl ethyl ketone, methyl isobutyl ketone and cyclohexanone, amide compounds such as N-methylpyrrolidone and dimethylformamide, and aliphatic hydrocarbons such as normal heptane, normal hexane and cyclohexane. These organic solvents may be used singly or as a mixture of two or more solvents.

Furthermore, the concentration of the photopolymerizable polymer dissolved or dispersed in the above-mentioned solvent is optional, but the concentration is 0.001 to 90% by mass, preferably 0.002 to 80% by mass, and more preferably 0.005 to 70% by mass, with respect to the gross mass (the total mass) of the photopolymerizable polymer and the solvent.

Then, after forming the coating film, the film is irradiated with an ultraviolet ray irradiation lamp such as a low pressure mercury lamp, high pressure mercury lamp, extra-high pressure mercury lamp and xenon lamp to form a cured film.

The irradiation can be carried out under an air or inert gas atmosphere. Especially, the photoirradiation under the atmosphere of an inert gas such as nitrogen or argon can shorten the curing time compared with the photoirradiation under the air atmosphere, because there is no oxygen which deactivates the radicals, which is desirable.

The reaction temperature is not specifically limited, but for example, the desirable reaction temperature is preferably 0 to 200° C., more preferably 10 to 150° C., and specifically preferably 20 to 100° C.

The intensity of a light source and the distance between a light source and substrate can be accordingly selected, because the intensity and distance are proportional to the curing speed.

Furthermore, the film thickness of a cured film formed from the film-forming material of the present invention is generally 1 μm or less, and specifically preferably 10 nm to 500 nm.

### EXAMPLES

Hereinafter, the present invention will be described in detail with reference to Examples, but the invention is not intended to be limited to Examples.

In the following Examples, the following apparatuses were used for the measurements of sample properties.

### (Measurement of Film Thickness)

Apparatus: Microfigure Measuring Instrument ET4000A manufactured by Kosaka Laboratory Ltd.

### (Gravimetric Analysis)

Apparatus: AT250 manufactured by Mettler-Toledo International Inc.

### (Hardness and Elasticity Tests (Nanoindentation))

Apparatus: ENT-2100 manufactured by ELIONIX Inc.

Indenter Used: Berkovich indenter

### Example 1 to Example 5

### Ultraviolet (UV) Curing Behavior of Photopolymerizable Polymer Thin Film

1200 μL of a toluene solution of a photopolymerizable polymer containing S-DC (N,N-diethyldithiocarbamylmethylstyrene) as a basic structure (10 wt % or 5 wt %) was spin coated on a glass substrate with 5×5 cm at 300 rpm for 5 seconds followed by at 2500 rpm for 20 seconds, and then the coated substrate was dried at 150° C. for 20 minutes.

The dried substrate was photoirradiated for 0.5 hours, 1 hour or 3 hours by using a 100-W high pressure mercury lamp (the distance from the light source: 5 cm) to be photo-cured, then immersed in 200 ml of toluene for 15 seconds to be washed, and dried at 150° C. for 20 minutes to remove uncured photopolymerizable polymers.

The cured ratio was determined from changes in film thicknesses and weights before and after the irradiation. The results are shown in Table 1.

TABLE 1
UV Curing Behavior of Photopolymerizable Polymer Thin Film

| | | | Film weight (mg) | | Film thickness (nm) | | |
|---|---|---|---|---|---|---|---|
| | | | Numbers in parentheses | | Numbers in | | |
| | | | represent residual film | | parentheses represent | | |
| | | | weight ratios | | residual film thickness ratios | | |
| | | Irradiation | Before | After irradiation | before | after | after |
| No. | Concentration | time | irradiation | and washing | irradiation | irradiation | washing |
| Example 1 | 10 wt % | 0.5 hr | 1.83 | 1.00 (54.0) | 470 | 466 | 348 (74.0) |
| Example 2 | | 1 hr | 1.75 | 1.30 (74.2) | 471 | 463 | 407 (86.4) |
| Example 3 | | 3 hr | 2.10 | 1.76 (83.8) | 483 | 481 | 392 (81.2) |
| Example 4 | 5 wt % | 0.5 hr | 0.75 | 0.51 (68.0) | — | 180 | 117 (65.0) |
| Example 5 | | 1 hr | 0.74 | 0.62 (84.0) | — | 175 | 151 (86.3) |

As shown in Table 1, in any Examples, cured films can be formed by ultraviolet irradiation.

### Example 3 and Comparative Example 1

### Hardness and Coefficient of Elasticity

As for the cured film manufactured in Example 3 (a concentration of 10%, a photoirradiation for 3 hours), the hardness and the coefficient of elasticity of the thin film were measured by nanoindentation.

Furthermore, the hardness and coefficient of elasticity of the coating film sample (Comparative Example 1: a concentration of 10%, no photoirradiation), which was manufactured in a similar procedure to that in Examples 1 to 5 except that the photoirradiation was not performed, were measured in the above-mentioned procedure.

The obtained results are shown in Table 2 (the applied load: 0.1 mN) and Table 3 (the applied load: 0.05 mN).

TABLE 2
Hardness and Coefficient of Elasticity (Applied Load: 0.1 mN)

| Measurement | | First | Second | Third | |
|---|---|---|---|---|---|
| item | Photoirradiation | sample | sample | sample | Average |
| Indentation | Yes | 518.0 | 581.9 | 597.6 | 565.9 |
| hardness | (Example 3) | | | | |
| (mN/mm²) | No | 368.2 | 365.6 | 366.9 | 366.9 |
| | (Comparative | | | | |
| | Example 1) | | | | |
| Coefficient | Yes | 1.012 × 10⁴ | 0.9659 × 10⁴ | 1.343 × 10⁴ | 1.107 × 10⁴ |
| of elasticity | (Example 3) | | | | |
| (mN/mm²) | No | 1.700 × 10⁴ | 1.963 × 10⁴ | 1.893 × 10⁴ | 1.852 × 10⁴ |
| | (Comparative | | | | |
| | Example 1) | | | | |

TABLE 3
Hardness and Coefficient of Elasticity (Applied Load: 0.05 mN)

| Measurement | | First | Second | Third | |
|---|---|---|---|---|---|
| item | Photoirradiation | sample | sample | sample | Average |
| Indentation | Yes | 734.8 | 699.6 | 678.4 | 704.3 |
| hardness | (Example 3) | | | | |
| (mN/mm²) | No | 456.8 | 4524 | 449.5 | 452.9 |
| | (Comparative | | | | |
| | Example 1) | | | | |
| Coefficient | Yes | 1.173 × 10⁴ | 1.206 × 10⁴ | 1.173 × 10⁴ | 1.184 × 10⁴ |
| of elasticity | (Example 3) | | | | |
| (mN/mm²) | No | 1.298 × 10⁴ | 1.469 × 10⁴ | 1.326 × 10⁴ | 1.364 × 10⁴ |
| | (Comparative | | | | |
| | Example 1) | | | | |

As shown in Table 2 and Table 3, with each of the loads applied, hardness increased by the photoirradiation (Example 3).

Schematic models of S-DC (N,N-diethyldithiocarbamylmethylstyrene) used in the present Examples and the photopolymerizable polymer obtained from the S-DC are shown below.

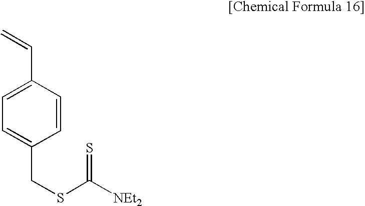

S-DC (N,N-diethyldithiocarbamylmethylstyrene)

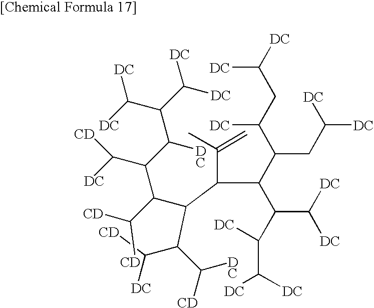

Schematic model of photopolymerizable polymer (benzene rings and the like are left out in the model. DC: dithiocarbamate group (see below))

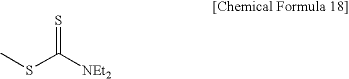

1. A curable material comprising:
a branched and/or linear photopolymerizable polymer having an N,N-dialkyldithiocarbamate group as a functional group at a molecular end.

2. The curable material according to claim 1, wherein the photopolymerizable polymer is a branched photopolymerizable polymer represented by Formula (1): 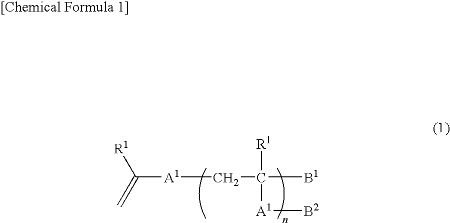
(where R¹ represents a hydrogen atom or a methyl group, A¹ represents Formula (2) or Formula (3): 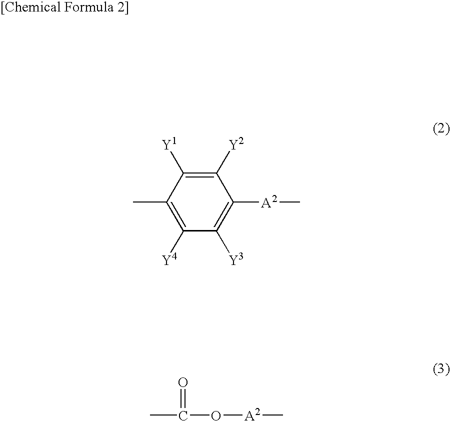
(where A² represents a straight chain, branched chain or cyclic alkylene group with 1 to 30 carbon atoms, which optionally contains an ether linkage or ester linkage, and Y¹, Y², Y³ or Y⁴ independently represents a hydrogen atom, alkyl group with I to 20 carbon atoms, alkoxy group with 1 to 20 carbon atoms, nitro group, hydroxy group, amino group, carboxyl group or cyano group), B¹ or B² independently represents a hydrogen atom, thiol group or dithiocarbamate group represented by Formula (4): 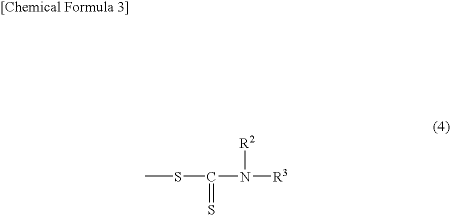
(where each of R² and R³ independently represents an alkyl group with I to 5 carbon atoms, hydroxyalkyl group with I to 5 carbon atoms or arylalkyl group with 7 to 12 carbon atoms, or R² and R³ are optionally bonded to each other to form a ring together with a nitrogen atom), and n is the number of a repeating unit structure and represents an integer of 2 to 100,000).

3. The curable material according to claim 1, wherein the photopolymerizable polymer is a linear photopolymerizable polymer represented by Formula (5): 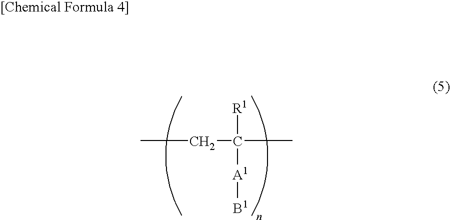
(where R¹, A¹, B¹ and n are the same as the respective definitions in Formula. (1)).

4. The curable material according to claim 2, wherein the photopolymerizable polymer represented by Formula (1) has a weight average molecular weight, measured by gel permeation chromatography converted to polystyrene, of 500 to 200,000.

5. The curable material according to claim 3, wherein the photopolymerizable polymer represented by Formula (5) has a weight average molecular weight, measured by gel permeation chromatography converted to polystyrene, of 500 to 200,000.

6. A film-forming material comprising:
the curable material as claimed in claim 1.

7. A cured object obtained by photopolymerization of the curable material as claimed in claim 1 to effect inter-bonding.

8. A cured film obtained by photopolymerization of the film-forming material as claimed in claim 6 to effect inter-bonding and form a film.
